(19) United States
(12) Patent Application Publication
(10) Pub. No.: US 2025/0103925 A1
(43) Pub. Date: Mar. 27, 2025

(54) DATA ANALYSIS DEVICE, DATA ANALYSIS METHOD, AND PROGRAM

(71) Applicant: Panasonic Intellectual Property Management Co., Ltd., Osaka (JP)

(72) Inventors: YIRAN JIANG, Osaka (JP); YUICHIRO SADANAGA, Osaka (JP); NOBUO HARA, Osaka (JP)

(21) Appl. No.: 18/977,744

(22) Filed: Dec. 11, 2024

Related U.S. Application Data
(63) Continuation of application No. PCT/JP2023/016233, filed on Apr. 25, 2023.

(30) Foreign Application Priority Data
Jun. 16, 2022 (JP) 2022-097192

(51) Int. Cl. G06N 5/045; G06F 17/18; G06N 3/045

(52) U.S. Cl. CPC G06N 5/045; G06F 17/18; G06N 3/045

(57) ABSTRACT

Data analysis device (1) includes data acquisition unit (10) that acquires a plurality of explanatory variables X and E and objective variable Y that can take different values depending on a time, first model derivation unit (30) that performs multiple regression analysis by using the plurality of explanatory variables X and E and objective variable Y and derives first model M1 indicating a relationship between the plurality of explanatory variables X and E and objective variable Y, change point detection unit (50) that detects change point Tc that is a time when a predetermined explanatory variable (for example, E) among the plurality of explanatory variables X and E changes beyond a predetermined range, and second model derivation unit (60) that corrects first model M1 based on predetermined explanatory variable E starting from change point Tc and derives second model M2 that is a corrected model.

### TECHNICAL FIELD

The present disclosure relates to a data analysis device that analyzes a plurality of pieces of data, a data analysis method, and a program for executing the data analysis method.

### BACKGROUND ART

In related art, a data analysis device that analyzes a plurality of pieces of data has been known. As an example of the device, PTL 1 describes a data analysis device that performs multiple regression analysis on a plurality of pieces of time-series data and predicts a future value by using the analysis result. Specifically, in the data analysis device of PTL 1, for an explanatory variable of actual measurement data to which order information such as time series is assigned, a term obtained by performing primary and secondary differentiation of a feature of data fluctuation according to the order information such as the time series in time or order is added as a new explanatory variable, and thus, a multiple regression model of an objective variable of the actual measurement data to which the order information such as the time series is assigned is calculated, and the objective variable in any date and time and order is predicted.

### CITATION LIST

### Patent Literature

PTL 1: Unexamined Japanese Patent Publication No. 2016-031714

### SUMMARY OF THE INVENTION

A data analysis device according to an aspect of the present disclosure includes a data acquisition unit that acquires a plurality of explanatory variables and an objective variable that takes different values depending on a time, a first model derivation unit that performs multiple regression analysis by using the plurality of explanatory variables and the objective variable and derives a first model indicating a relationship between the plurality of explanatory variables and the objective variable, a change point detection unit that detects a change point that is a time when a predetermined explanatory variable among the plurality of explanatory variables changes beyond a predetermined range, and a second model derivation unit that corrects the first model based on the predetermined explanatory variable starting from the change point and derives a second model that is a corrected model.

A data analysis method according to another aspect of the present disclosure includes acquiring a plurality of explanatory variables and an objective variable that take different values depending on a time, performing multiple regression analysis by using the plurality of explanatory variables and the objective variable and deriving a first model indicating a relationship between the plurality of explanatory variables and the objective variable, detecting a change point that is a time when a predetermined explanatory variable among the plurality of explanatory variables changes beyond a predetermined range, and correcting the first model based on the predetermined explanatory variable starting from the change point, and deriving a second model that is a corrected model.

Note that, comprehensive or specific aspects may be implemented by a system, a method, an integrated circuit, a computer program, or a computer-readable recording medium such as a CD-ROM, or may be implemented by any combination of the system, the method, the integrated circuit, the computer program, and the recording medium.

### BRIEF DESCRIPTION OF THE DRAWINGS

FIG. 1 is a diagram illustrating an example of a data analysis system according to an exemplary embodiment.

FIG. 2 is a diagram illustrating a configuration of the data analysis device according to the exemplary embodiment.

FIG. 3 is a diagram illustrating an example of a data set according to the exemplary embodiment.

FIG. 4 is a diagram illustrating an example of an explanatory variable and an objective variable selected from the data set according to the exemplary embodiment.

FIG. 5 is a block diagram illustrating a functional configuration of the data analysis device according to the exemplary embodiment.

FIG. 6 is a diagram illustrating a first explanatory variable, a second explanatory variable, and an objective variable, which are a plurality of pieces of data acquired by the data analysis device according to the exemplary embodiment.

FIG. 7 is a diagram illustrating a first prediction error that is a difference between a first prediction value calculated based on a first model and an objective variable obtained by actual measurement.

FIG. 8 is a diagram illustrating a reference prediction error that is a difference between a reference prediction value calculated from a reference model that does not include a second explanatory variable and an objective variable obtained by actual measurement.

FIG. 9 is a diagram illustrating an example of a change point score of a second explanatory variable.

FIG. 10 is a diagram illustrating another example of the change point score of the second explanatory variable.

FIG. 11 is a diagram illustrating a second prediction error that is a difference between a second prediction value calculated based on a second model and an objective variable obtained by actual measurement.

FIG. 12 is a flowchart illustrating a data analysis method according to the exemplary embodiment.

FIG. 13 is a block diagram illustrating a functional configuration of a data analysis device according to a modification of the exemplary embodiment.

### DESCRIPTION OF EMBODIMENT

In the analysis device described in PTL 1, for example, in a case where there is an uncertain element that influences the objective variable in the actual measurement data, it is difficult to accurately analyze the plurality of pieces of data. Thus, it is difficult to accurately predict the future value.

The present disclosure has been made to solve the above problems, and an object of the present disclosure is to provide a data analysis device and the like capable of accurately analyzing a plurality of pieces of data.

Hereinafter, exemplary embodiments will be described with reference to the drawings. The exemplary embodiments and the like to be described below provide comprehensive or specific examples. Numerical values, shapes, materials, constituent elements, disposition positions and connection modes of the constituent elements, steps, order of the steps, and the like illustrated in the following exemplary embodiments and the like are merely examples, and therefore are not intended to limit the present disclosure. In addition, of constituent elements in the following exemplary embodiments and the like, constituent elements that are not recited in the independent claims will be described as optional constituent elements.

In addition, the drawings are schematic views and are not necessarily strictly illustrated. In addition, in the drawings, substantially the same components are denoted by the same reference numerals, and redundant description may be omitted or simplified. In addition, even in a case where the same object is illustrated in the drawings, a scale may be changed for the sake of convenience.

### Exemplary Embodiment

### [Hardware Configuration]

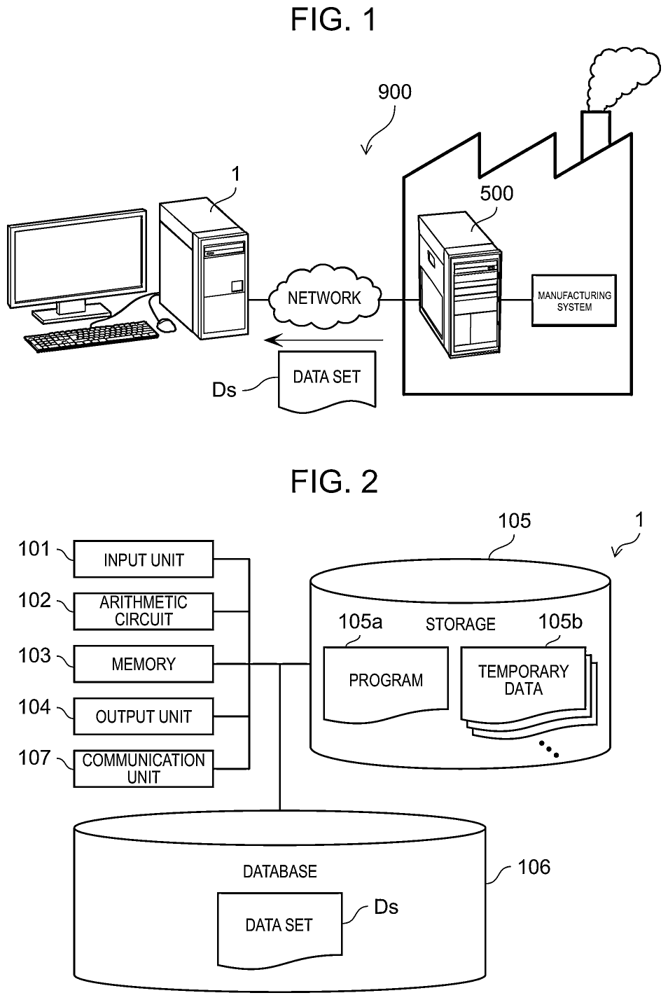

FIG. 1 is a diagram illustrating an example of a data analysis system according to the present exemplary embodiment.

Data analysis system 900 according to the present exemplary embodiment includes data analysis device 1 and manufacturing management device 500.

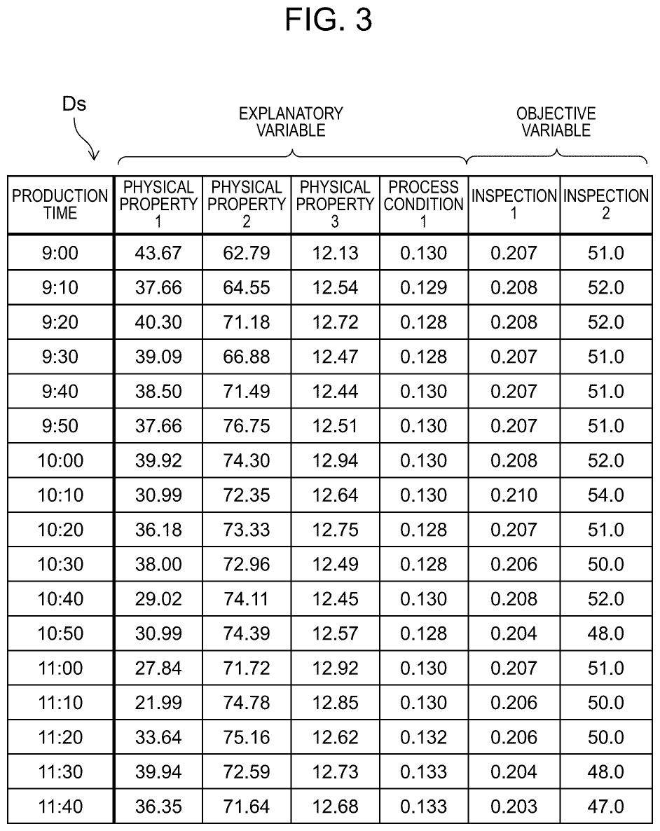

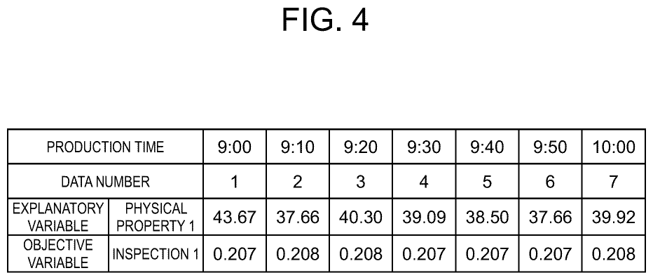

Manufacturing management device 500 is, for example, a device that is installed in a manufacturing factory and manages a manufacturing system for manufacturing a product. Manufacturing management device 500 transmits data set Ds obtained by the manufacturing system to data analysis device 1 via a network such as the Internet. Note that, details of data set Ds will be described later with reference to FIGS. 3 and 4.

Data analysis device 1 includes a personal computer or the like, and receives data set Ds from manufacturing management device 500. Then, data analysis device 1 according to the present exemplary embodiment generates a plurality of models indicating a relationship between data of an explanatory variable and data of an objective variable based on data set Ds.

FIG. 2 is a diagram illustrating a configuration of data analysis device 1 according to the present exemplary embodiment.

Data analysis device 1 includes input unit 101, arithmetic circuit 102, memory 103, output unit 104, storage 105, database 106, and communication unit 107.

Communication unit 107 communicates with a device outside data analysis device 1. This communication may be wired communication or wireless communication. The wireless communication method may be Wi-Fi (registered trademark), Bluetooth (registered trademark), or ZigBee, or may be other methods. For example, communication unit 107 communicates with manufacturing management device 500 and receives data set Ds from manufacturing management device 500.

Input unit 101 has a function as a human machine interface (HMI) that receives an input operation by a user, and includes, for example, a keyboard, a mouse, a touch sensor, a touch pad, and the like.

Output unit 104 includes a display that displays an image, characters, or the like, and the display is, for example, a liquid crystal display, a plasma display, an organic electro-luminescence (EL) display, or the like. Note that, output unit 104 may include a printer that prints an image, characters, or the like, and may have a function of storing data output from arithmetic circuit 102 in storage 105 in a file format.

Storage 105 stores program (that is, computer program) 105a in which each command to arithmetic circuit 102 is described. In addition, each temporary data 105b temporarily generated by processing of arithmetic circuit 102 may be stored in storage 105. Note that, such a storage 105 is a non-volatile recording medium, and is, for example, a magnetic storage device such as a hard disk, an optical disk, a semiconductor memory, or the like. Note that, program 105a is provided to data analysis device 1 via, for example, a removable medium or a network, and is stored in storage 105. The removable medium is, for example, a compact disc read only memory (CD-ROM), a flash memory, or the like. Thus, communication unit 107 may include an interface that reads program 105a of the removable medium.

Program 105a read and loaded by arithmetic circuit 102 is temporarily stored in memory 103. Such a memory 103 is, for example, a volatile random access memory (RAM).

Arithmetic circuit 102 is a circuit that executes program 105a loaded in memory 103, and is, for example, a central processing unit (CPU), a graphics processing unit (GPU), or the like. Arithmetic circuit 102 may use each temporary data 105b stored in storage 105 when program 105a is executed.

Similarly to storage 105, database 106 is a non-volatile recording medium, and is, for example, a magnetic storage device such as a hard disk, an optical disk, a semiconductor memory, or the like. For example, arithmetic circuit 102 acquires data set Ds from manufacturing management device 500 via the network and communication unit 107, and stores data set Ds in database 106.

Note that, in the present exemplary embodiment, storage 105 and database 106 are different recording media, but storage 105 and database 106 may be constituted as one recording medium including the storage and the database.

### [Data Set]

FIG. 3 is a diagram illustrating an example of data set Ds according to the present exemplary embodiment.

Data set Ds is a raw data set transmitted from manufacturing management device 500, and is, for example, a structured data set including a plurality of pieces of manufacturing data indicating physical properties in a manufacturing process of the above-described manufacturing system, process conditions, quality of a product manufactured by the manufacturing process, and the like. As illustrated in FIG. 3, such a data set Ds indicates variable names of a plurality of variables and pieces of data of the variables. Note that, the data may be any data as long as the data indicates at least one of a character and a number. The variable name of each of the plurality of variables is arranged in a first row of data set Ds, and the data of each of the plurality of variables is arranged in each of second and subsequent rows of data set Ds.

Note that, in a leftmost row of data set Ds, a time at which production is performed by manufacturing management device 500 is illustrated.

As illustrated in FIG. 3, in the first row of data set Ds, physical property 1, physical property 2, physical property 3, process condition 1, inspection 1, and inspection 2, which are variable names, are arranged. Physical property 1, physical property 2, and physical property 3 are appropriately selected from among, for example, viscosity, a particle size, a solid content ratio, and the like. Process condition 1 is appropriately selected from among, for example, a flow rate, a pressure, and the like. Inspection 1 and inspection 2 are inspection items of a product or a semi-product when the product or the semi-product manufactured under physical property 1, physical property 2, physical property 3, and process condition 1. Inspection 1 and inspection 2 are appropriately selected from among, for example, a coating weight, a film thickness, a coating area, and the like. The second and subsequent rows of data set Ds include pieces of data of variables identified by these variable names.

In the present exemplary embodiment, physical property 1, physical property 2, physical property 3, and process condition 1 illustrated in FIG. 3 are explanatory variables, and inspection 1 and inspection 2 are objective variables. In this example, four types of explanatory variables are shown, and two types of objective variables are shown. Note that, the process conditions are not limited to one type, and may be two or more types.

FIG. 4 is a diagram illustrating examples of the explanatory variable and the objective variable selected from data set Ds. FIG. 4 illustrates a state where physical property 1 and inspection 1 are selected from data set Ds illustrated in FIG. 3 and are arranged for each production time. In addition, in FIG. 4, a data number corresponding to a time is assigned to each production time. In the drawing, physical property 1 is selected as the explanatory variable, and inspection 1 is selected as the objective variable.

Note that, a method for selecting the explanatory variable and the objective variable is not limited thereto. For example, from data set Ds, physical property 2 may be selected as the explanatory variable, and inspection 2 may be selected as the objective variable. In addition, physical property 1 and physical property 2 may be selected as the explanatory variables, and inspection 1 may be selected as the objective variable. Physical property 1, physical property 2, and physical property 3 may be selected as the explanatory variables, and inspection 1 may be selected as the objective variable. That is, two or more types of explanatory variables and one type of objective variable may be selected.

In addition, in FIG. 4, the time is selected every 10 minutes, but the method for selecting the time is not limited thereto. For example, 9:00, 9:20, and 9:40 may be selected at intervals of 20 minutes from 9:00 to 9:59 of data set Ds, 10:00, 10:20, and 10:40 may be selected at intervals of 20 minutes from 10:00 to 10:59, and 110:00, 11:20, and 11:40 may be selected at intervals of 20 minutes from 11:00 to 11:40.

The data analysis device of the present exemplary embodiment performs data analysis on data set Ds as exemplified above. Note that, in order to facilitate understanding of the invention, the explanatory variable and the objective variable described above will be further simplified and described below.

### [Configuration of Data Analysis Device]

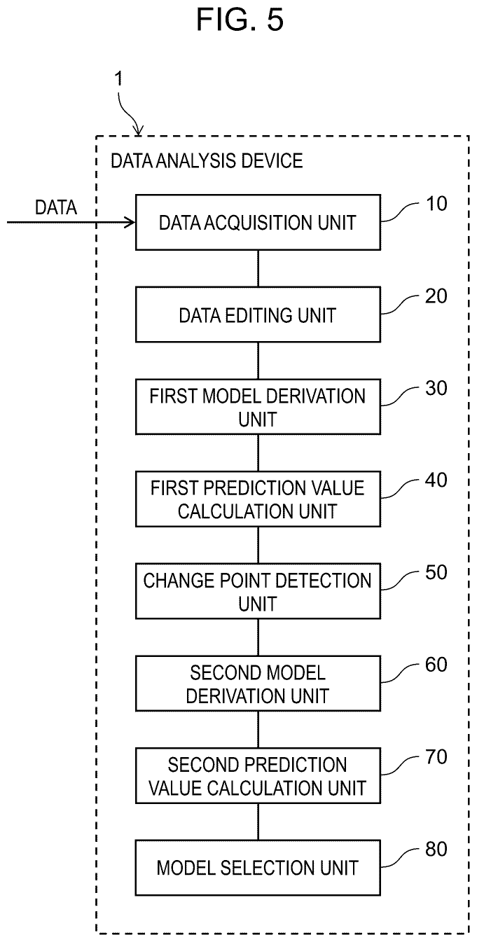

Next, a configuration of data analysis device according to the exemplary embodiment will be described with reference to FIG. 5 to FIG. 11.

FIG. 5 is a block diagram illustrating a functional configuration of data analysis device 1 according to the exemplary embodiment.

As illustrated in FIG. 5, data analysis device 1 includes data acquisition unit 10 that acquires data, data editing unit 20 that accumulates data, first model derivation unit 30 that derives first model M1 based on data, and first prediction value calculation unit 40 that predicts data based on first model M1. In addition, data analysis device 1 further includes change point detection unit 50 that detects a change point of data, second model derivation unit 60 that corrects first model M1 and derives second model M2, second prediction value calculation unit 70 that predicts data based on second model M2, and model selection unit 80 that selects a model to be used in the future. A functional configuration of data analysis device 1 is implemented by executing a program stored in storage 105.

Data acquisition unit 10 acquires a plurality of pieces of data from an outside. For example, data acquisition unit 10 acquires a plurality of pieces of data by an operation input by a user who uses data analysis device 1, a data input by an external device, or the like.

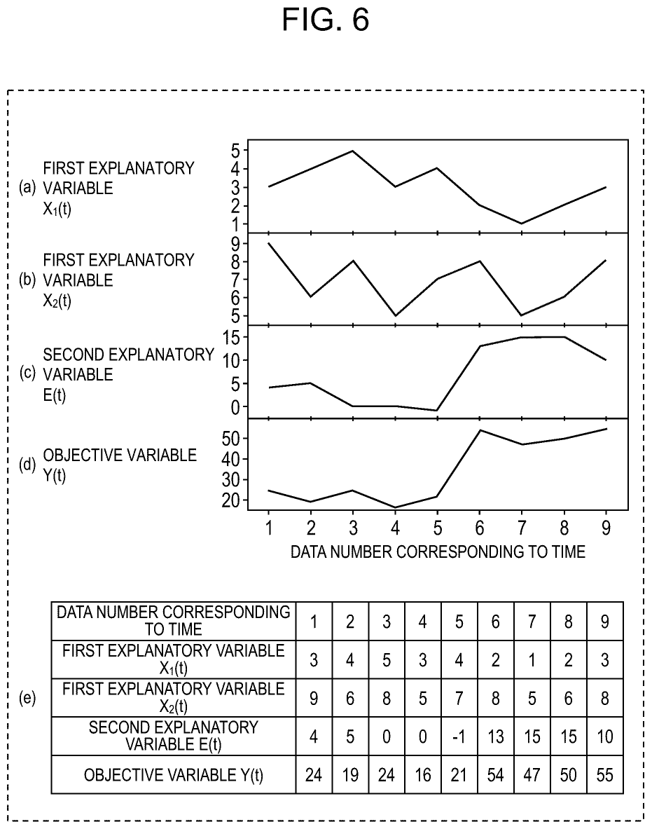

FIG. 6 is a diagram illustrating first explanatory variable X, second explanatory variable E, and objective variable Y which are a plurality of pieces of data acquired by data analysis device 1.

Graphs of (a) to (d) of FIG. 6 represent a plurality of pieces of data organized in time series, and a table of (e) of FIG. 6 represents data on which each graph is based is represented. Note that, FIG. 6 illustrates a data set different from FIG. 3.

The plurality of pieces of data are pieces of actual measurement data such as manufacturing conditions and pieces of manufacturing actual measurement data. The plurality of pieces of data include first explanatory variable X and second explanatory variable E, which are data to be a cause, and objective variable Y, which is data to be a result, among the cause and the result. Each of first explanatory variable X, second explanatory variable E, and objective variable Y is represented by, for example, a physical quantity of a SI basic unit such as a length, a mass, a current, a temperature, and a time. Each of first explanatory variable X, second explanatory variable E, and objective variable Y can take different values depending on the time.

Data editing unit 20 edits first explanatory variable X, second explanatory variable E, and objective variable Y acquired by data acquisition unit 10 in association with the production time. For example, data editing unit 20 sorts first explanatory variable X, second explanatory variable E, and objective variable Y in ascending order of time to obtain time-series data. In a case where the pieces of manufacturing actual measurement are used, the pieces of actual measurement data may be sorted based on a manufacturing order, and for example, the pieces of manufacturing actual measurement data may be edited in ascending order of manufacturing time.

As described above, first explanatory variable X, second explanatory variable E, and objective variable Y are edited in accordance with the time to become time-series data indicating a temporal change of the physical quantity. Data editing unit 20 stores the edited time-series data in database 106.

Here, each variable to be the time-series data is represented as first explanatory variable Xₖ(t), second explanatory variable E(t), and objective variable Y(t). t is a data number corresponding to time, and k is a number indicating a type of data. Note that, hereinafter, t may be simply referred to as “time”.

First explanatory variable Xₖ(t) is a variable having a high contribution degree to objective variable Y(t). First explanatory variable Xₖ(t) includes one or more explanatory variables such as explanatory variable X₁(t) related to a manufacturing process condition and explanatory variable X₂(t) related to a facility part state (for example, the number of component shots).

Second explanatory variable E(t) is, for example, an explanatory variable such as a physical property value of a material. Second explanatory variable E(t) is also a variable having a high contribution degree to objective variable Y(t), but has an uncertain element, and a component contributing to objective variable Y(t) may fluctuate. The uncertain element is an external factor that is difficult to control, such as trouble stop, lot replacement of a material, a measurement environment, or the like. Thus, second explanatory variable E(t) has a larger fluctuation coefficient than first explanatory variable Xₖ(t). The fluctuation coefficient is a value obtained by dividing a standard deviation indicating a dispersion degree of data by an average value. A data group of second explanatory variable E(t) may include a plurality of populations.

Objective variable Y(t) is a numerical value reflecting the quality of a manufactured object, such as an inspection value of an intermediate product or a manufactured product. Note that, objective variable Y(t) may be a value indicating a determination result on the quality of the product.

As illustrated in FIG. 6, each of first explanatory variable X₁(t) and X₂(t), second explanatory variable E(t), and objective variable Y(t) changes in accordance with the time. Note that, these variables and times are illustrated in simplified numerical values in the drawing. The plurality of pieces of data and pieces of information regarding the times are stored in database 106 and are output to first model derivation unit 30 and second model derivation unit 60 to be described later.

First model derivation unit 30 performs multiple regression analysis by using the plurality of explanatory variables X₁(t), X₂(t), and E(t) and objective variable Y(t) to derive first model M1 indicating a relationship between the plurality of explanatory variables X₁(t), X₂(t), and E(t) and objective variable Y(t). First model M1 is a model for predicting future values of the plurality of explanatory variables X₁(t), X₂(t), and E(t) and objective variable Y(t). First model M1 is defined by the following (Equation 1).

$$\begin{matrix}[ Math . 1 ] & \\ Y = {β}_{0} + {\sum }_{k = 1}^{K} {β}_{k} {X}_{k} + {β}_{k + 1} E & ( Formula 1 )\end{matrix}$$

In (Equation 1), Y is an objective variable, Xₖ is a first explanatory variable, and E is a second explanatory variable. k is a number of the first explanatory variable. β₀ is a regression constant, and βₖ and βₖ₊₁ are multiple regression coefficients. First model M1 is derived by inputting the data illustrated in FIG. 6 to (Equation 1) and performing multiple regression analysis. First model M1 derived by first model derivation unit 30 is stored in database 106.

First prediction value calculation unit 40 calculates first prediction value P1(t) corresponding to objective variable Y(t) based on first model M1. Specifically, first prediction value calculation unit 40 calculates first prediction value P1(t) corresponding to objective variable Y(t) by substituting first explanatory variable Xₖ(t) and second explanatory variable E(t) into first model M1.

Here, in order to verify the accuracy of first model M1, a difference between first prediction value P1(t) calculated based on first model M1 and objective variable Y(t) obtained by actual measurement is confirmed.

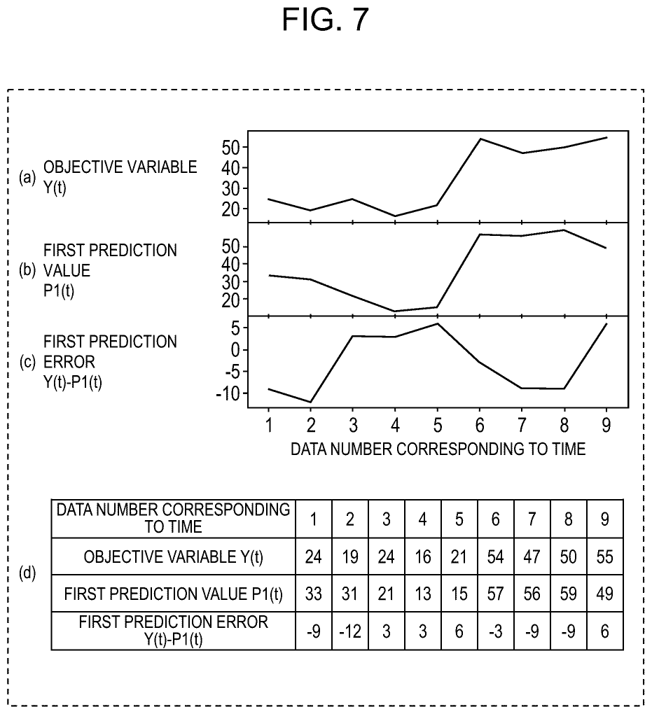

FIG. 7 is a diagram illustrating a first prediction error that is a difference between first prediction value P1(t) calculated based on first model M1 and objective variable Y(t) obtained by actual measurement.

In a graph of (a) of FIG. 7, objective variable Y(t) obtained by actual measurement is represented. This graph is the same as (d) in FIG. 6. A graph of (b) of FIG. 7 represents first prediction value P1(t) calculated based on first model M1. The first prediction error is represented in a graph of (c) of FIG. 7. The first prediction error is a value obtained by subtracting the first prediction value from the objective variable that is an actual measurement value, and is calculated by an expression of Y(t)−P1(t). In a table of (d) of FIG. 7, data on which each graph is based is represented.

As illustrated in the drawing, the first prediction error increases or decreases with reference to zero. That is, first prediction value P1(t) calculated based on first model M1 does not coincide with objective variable Y(t) which is the actual measurement value. As described above, when the data illustrated in FIG. 6 is used as it is, that is, when the model is generated by using data including the uncertain element, the accuracy of the model may deteriorate.

Therefore, a case where second explanatory variable E(t) including the uncertain element is removed from first model M1 will be considered.

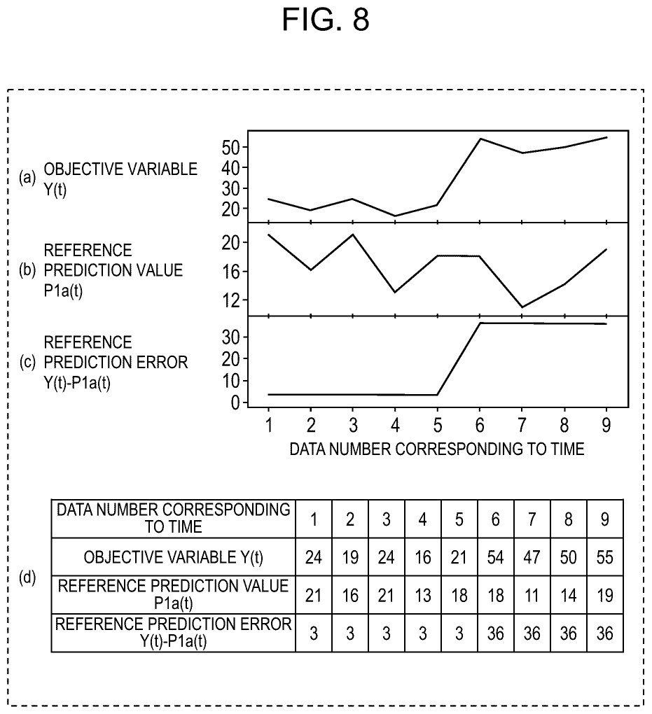

FIG. 8 is a diagram illustrating a reference prediction error that is a difference between reference prediction value P1a(t) calculated from reference model M1a that does not include second explanatory variable E(t) and objective variable Y(t) obtained by actual measurement.

In a graph of (a) of FIG. 8, objective variable Y(t) obtained by actual measurement is represented. This graph is the same as (d) in FIG. 6.

A graph in (b) of FIG. 8 represents reference prediction value P1a(t) calculated from reference model M1a. Reference model M1a is obtained by removing (βₖ₊₁E), which is a third term of first model M1, from first model M1, and is expressed by the following (Equation 2).

$$\begin{matrix}[ Math . 2 ] & \\ Y = {β}_{0} + {\sum }_{k = 1}^{K} {β}_{k} {X}_{k} & ( Formula 2 )\end{matrix}$$

Reference prediction value P1a(t) is calculated by substituting first explanatory variable Xₖ(t) into reference model M1a.

A graph in part (c) of FIG. 8 represents the reference prediction error that is the difference between reference prediction value P1a(t) and objective variable Y(t). The reference prediction error is a value obtained by subtracting the reference prediction value from the objective variable, and is calculated by an expression of Y(t)−P1a(t). In a table of (d) of FIG. 8, data on which each graph is based is represented.

The reference prediction error illustrated in the drawing has a small value from time 0 to time 5, but suddenly increases after time 6. That is, reference prediction value P1a(t) calculated based on reference model M1a substantially coincides with objective variable Y(t) until time 5, and does not coincide after time 6. The reason why reference prediction value P1a(t) does not coincide with objective variable Y(t) is that the component contributing to objective variable Y(t) of second explanatory variable E(t) greatly changes from time 5 to time 6, and has a large influence on objective variable Y(t). Therefore, it is considered that the accuracy of the model can be improved by determining the time at which second explanatory variable E(t) greatly changes and generating a model corresponding to the change. Thus, data analysis device 1 according to the present exemplary embodiment includes change point detection unit 50 that detects the change point of the data.

Change point detection unit 50 detects change point Tc that is a time when a predetermined explanatory variable among the plurality of explanatory variables X₁, X₂, and E changes beyond a predetermined range. In the present exemplary embodiment, a case where an explanatory variable that is a detection target of change point Tc is second explanatory variable E(t) will be described.

Change point detection unit 50 determines whether or not second explanatory variable E(t) exceeds a predetermined range by using change point score Sc indicating a degree of change of second explanatory variable E(t). Change point score Sc is calculated by using a change point detection algorithm. The change point detection algorithm is, for example, “ChangeFinder (registered trademark)”. Note that, change point Tc may be derived by a k-nearest neighbor algorithm, an autoregressive (AR) model, an autoregressive moving average (ARMA) model, or Relative unconstrained Least-Squares Importance Fitting (RuLSIF).

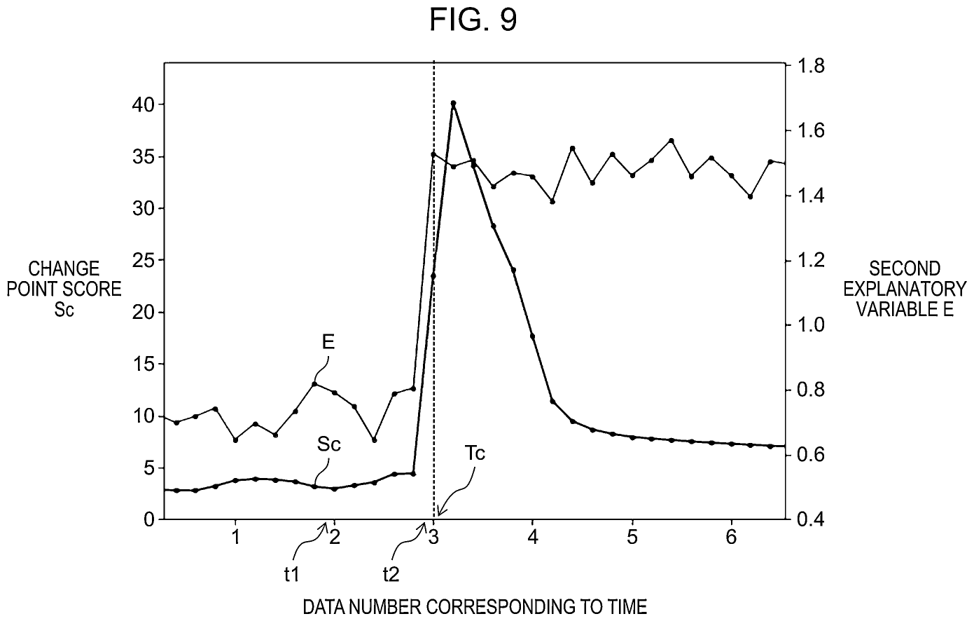

FIG. 9 is a diagram illustrating an example of change point score Sc of second explanatory variable E.

In the drawing, a horizontal axis represents time, and a vertical axis represents the data of second explanatory variable E and change point score Sc. Change point detection unit 50 calculates change point score Sc of second explanatory variable E based on the time-series data of second explanatory variable E. For example, in a case where change point score Sc at second time t2, which is a time next to first time t1, is twice or more change point score Sc at first time t1, change point detection unit 50 determines that second explanatory variable E exceeds the predetermined range. In the drawing, it is determined that there is change point Tc at time 3 indicated by a broken line. Note that, although change point Tc can be determined by using second explanatory variable E, it is desirable to determine change point Tc by using change point score Sc in order for change point Tc to be less influenced by disturbance, noise, or the like that occurs suddenly.

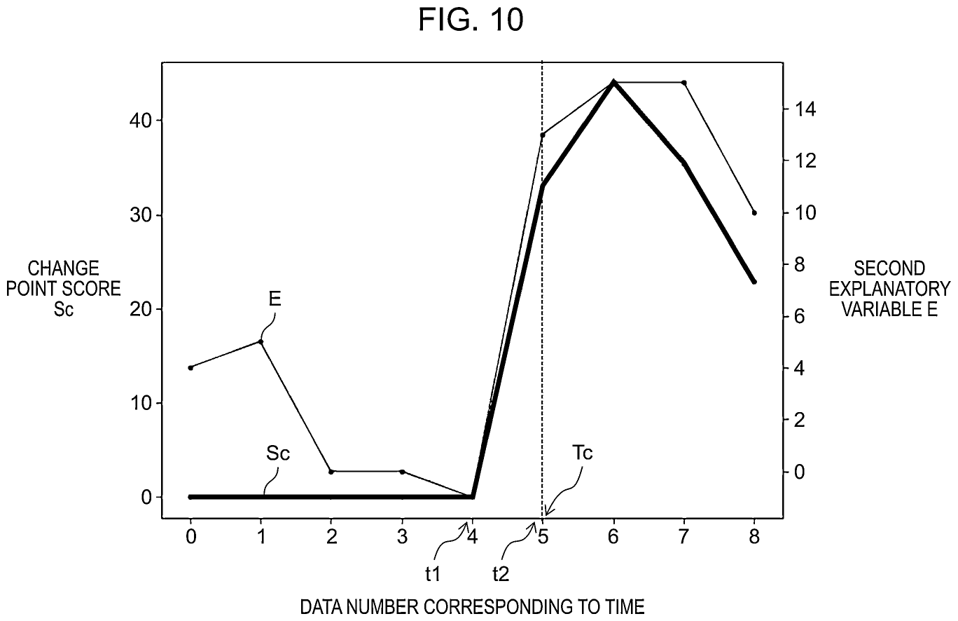

FIG. 10 is a diagram illustrating another example of change point score Sc of second explanatory variable E.

In the drawing, a horizontal axis represents time, and a vertical axis represents the data of second explanatory variable E and change point score Sc. Change point detection unit 50 calculates change point score Sc of second explanatory variable E based on the time-series data of second explanatory variable E. For example, in a case where change point score Sc at second time t2 is larger than change point score Sc at first time t1 by 20 or more, change point detection unit 50 determines that second explanatory variable E exceeds the predetermined range. In the drawing, it is determined that there is change point Tc at time 5 indicated by a broken line.

In the present exemplary embodiment, first model M1 is corrected by using a plurality of pieces of data starting from change point Tc detected by change point detection unit 50. Hereinafter, an example of a method for correcting first model M1 will be described.

Second model derivation unit 60 corrects first model M1 based on second explanatory variable E(t) starting from change point Tc, and derives second model M2 that is a corrected model. Second model M2 is also a model for predicting future values of the plurality of explanatory variables X₁(t), X₂(t), and E(t) and objective variable Y(t).

For example, second model derivation unit 60 corrects first model M1 by comparing second explanatory variable E(t) at change point Tc with second explanatory variable E(t) at a time before change point Tc. Specifically, in a case where there is change point Tc at the time t, second model derivation unit 60 calculates a moving average of second explanatory variable E at time (t−1), time (t−2), . . . , and time (t−n), and calculates difference ΔE that is a difference between the moving average and second explanatory variable E(t) at time t. Difference ΔE is expressed by the following (Equation 3). Note that, n is an integer of 1 or more.

$$\begin{matrix}[ Math . 3 ] & \\ Δ E = E ( t ) - \frac{{\sum }_{n = 1}^{N} E ( t - n )}{N} & ( Formula 3 )\end{matrix}$$

Second model derivation unit 60 calculates change amount ΔY_{E} by multiplying difference ΔE in (Equation 3) by multiple regression coefficient βₖ₊₁ in (Equation 1). Change amount ΔY_{E} is expressed by the following (Equation 4).

$$\begin{matrix}[ Math . 4 ] & \\ Δ {Y}_{E} = {β}_{k + 1} Δ E & ( Formula 4 )\end{matrix}$$

Then, second model derivation unit 60 corrects first model M1 by replacing a third term of first model M1 represented in (Equation 1) with change amount ΔY_{E}. Second model M2, which is a corrected model of first model M1, is defined by the following (Equation 5).

$${Y}^{′} = {β}_{0} + {\sum }_{k = 1}^{K} {β}_{k} {X}_{k} + Δ {Y}_{E} \qquad ( Formula 5 )$$

As described above, second model derivation unit 60 obtains a difference in the moving average between second explanatory variable E at change point Tc and second explanatory variable E at the time before change point Tc, and corrects first model M1 based on the difference. Second model M2 derived by second model derivation unit 60 is stored in database 106.

Second prediction value calculation unit 70 calculates second prediction value P2(t) corresponding to objective variable Y(t) based on second model M2. Specifically, second prediction value calculation unit 70 calculates second prediction value P2(t) corresponding to objective variable Y(t) by substituting first explanatory variable Xₖ(t) and second explanatory variable E(t) into second model M2.

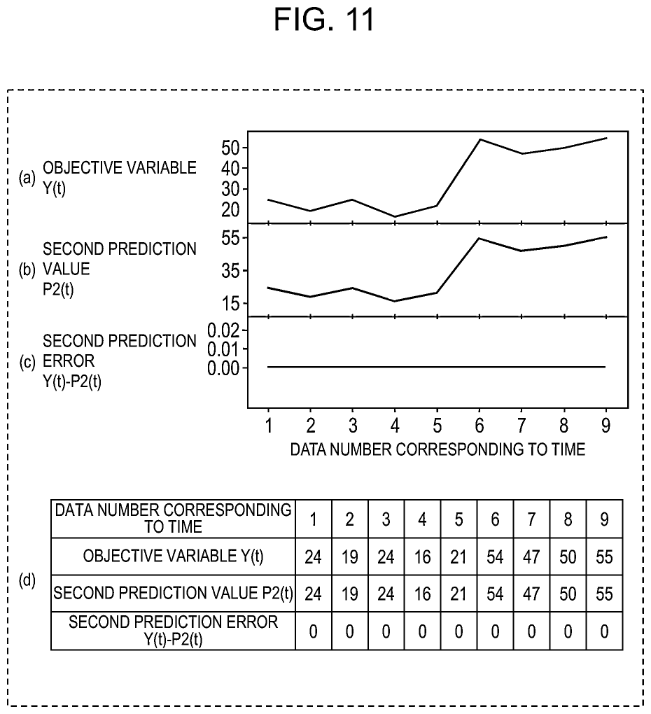

FIG. 11 is a diagram illustrating a second prediction error that is a difference between second prediction value P2(t) calculated based on second model M2 and objective variable Y(t) obtained by actual measurement.

A graph in (a) of FIG. 11 represents objective variable Y(t) obtained by actual measurement. This graph is the same as (d) in FIG. 6. A graph in (b) of FIG. 11 represents second prediction value P2(t) calculated based on second model M2. The second prediction error is represented in a graph of (c) of FIG. 11. The second prediction error is a value obtained by subtracting the second prediction value from the objective variable that is the actual measurement value, and is calculated by an expression of Y(t)−P2(t). In a table of (d) of FIG. 11, data on which each graph is based is represented.

As illustrated in the drawing, the second prediction error substantially coincides with reference to zero. That is, second prediction value P2(t) calculated based on second model M2 substantially coincides with objective variable Y(t) which is the actual measurement value. As described above, the prediction accuracy of the data is improved by using second model M2 obtained by correcting first model M1.

Model selection unit 80 selects a model to be used in the future from first model M1 and second model M2 based on first prediction value P1 and second prediction value P2. Specifically, model selection unit 80 compares the first prediction error with the second prediction error, and selects a model with a small error as the model to be used in the future. The future is a time later than a time when second model M2 is derived. In the examples illustrated in FIGS. 7 and 11, second model M2 is selected as the model to be used in the future. Note that, in a case where first prediction value P1 has a smaller error than second prediction value P2, first model M1 may be selected. The model selected by model selection unit 80 is stored in database 106.

Output unit 104 (see FIG. 2) is, for example, a display such as a liquid crystal panel, and displays explanatory variables X and E or objective variable Y predicted based on first model M1 or second model M2. Note that, output unit 104 may display first model M1 and second model M2.

As described above, data analysis device 1 includes data acquisition unit 10 that acquires the plurality of explanatory variables X and E and objective variable Y that can take different values depending on the time, first model derivation unit 30 that performs the multiple regression analysis by using the plurality of explanatory variables X and E and objective variable Y and derives first model M1 indicating the relationship between the plurality of explanatory variables X and E and objective variable Y, change point detection unit 50 that detects change point Tc that is the time when the predetermined explanatory variable (for example, E) among the plurality of explanatory variables X and E changes beyond the predetermined range, and second model derivation unit 60 that corrects first model M1 based on predetermined explanatory variable E starting from change point Tc and derives second model M2 that is the corrected model.

As described above, the accuracy of second model M2, which is the corrected model, can be improved by detecting change point Tc of predetermined explanatory variable E and correcting first model M1 based on predetermined explanatory variable E starting from change point Tc. As a result, it is possible to provide data analysis device 1 capable of accurately analyzing the plurality of pieces of data.

### [Data Analysis Method]

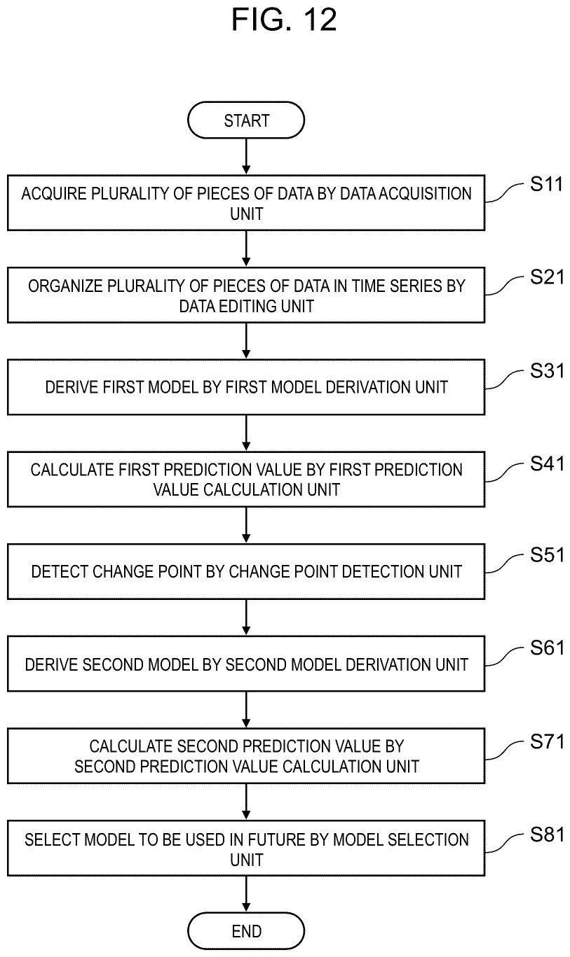

An example of a data analysis method according to the exemplary embodiment will be described with reference to FIG. 12.

FIG. 12 is a flowchart illustrating a data analysis method according to the exemplary embodiment.

First, data acquisition unit 10 of data analysis device 1 acquires the plurality of pieces of data as illustrated in FIG. 6 (step S11). The plurality of pieces of data are, for example, manufacturing actual measurement, and includes first explanatory variable X, second explanatory variable E, and objective variable Y.

Subsequently, data editing unit 20 organizes the plurality of pieces of data in time series (step S21). Specifically, data editing unit 20 sorts the plurality of pieces of data in ascending order of manufacturing time. For example, the data numbers corresponding to the times are sequentially assigned to the plurality of pieces of data organized in time series. The data edited by data editing unit 20 is stored in database 106.

Note that, in a case where the pieces of data organized in time series from the beginning are input to data acquisition unit 10, step S21 may be omitted. In addition, in a case where first explanatory variable X, second explanatory variable E, and objective variable Y are not set in advance in the plurality of pieces of data input to data acquisition unit 10, first explanatory variable X, second explanatory variable E, and objective variable Y may be set in data acquisition unit 10 or data editing unit 20.

Subsequently, first model derivation unit 30 performs multiple regression analysis by using first explanatory variable X, second explanatory variable E, and objective variable Y to derive first model M1 indicating the relationship between first explanatory variable X, second explanatory variable E, and objective variable Y (step S31).

First prediction value calculation unit 40 calculates first prediction value P1 corresponding to objective variable Y based on first model M1 (step S41). Note that, step S41 may be executed between steps S61 and S71 to be described later, or may be executed between steps S71 and S81.

Subsequently, change point detection unit 50 detects change point Tc which is a time when second explanatory variable E changes beyond the predetermined range (step S51). Change point detection unit 50 determines whether or not second explanatory variable E(t) exceeds a predetermined range by using change point score Sc indicating a degree of change of second explanatory variable E(t). In a case where change point Tc is not detected, first model M1 is used as a model for predicting future data. When change point Tc is detected, the process proceeds to the next step of deriving second model M2.

Second model derivation unit 60 corrects first model M1 based on second explanatory variable E(t) starting from change point Tc, and derives second model M2 that is the corrected model (step S61). For example, second model derivation unit 60 corrects first model M1 by comparing second explanatory variable E(t) at change point Tc with second explanatory variable E(t) at a time before change point Tc.

Second prediction value calculation unit 70 calculates second prediction value P2 corresponding to objective variable Y based on second model M2 (step S71).

Subsequently, model selection unit 80 selects the model to be used in the future from first model M1 and second model M2 based on first prediction value P1 and second prediction value P2 (step S81). Specifically, model selection unit 80 compares the first prediction error with the second prediction error, and selects a model with a small error as the model to be used in the future.

Data analysis device 1 performs future data analysis based on the model selected by model selection unit 80. Through these steps S11 to S81, the plurality of pieces of data can be accurately analyzed.

### Modification of Exemplary Embodiment

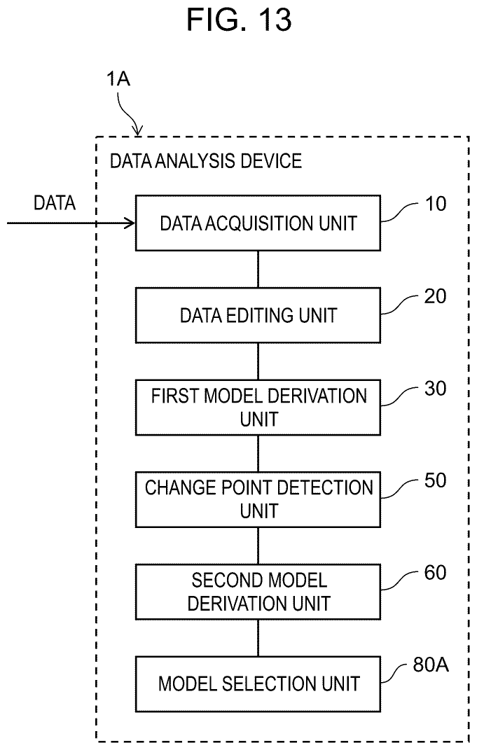

A configuration of data analysis device 1A according to a modification of the exemplary embodiment will be described with reference to FIG. 13. In the modification, an example in which second model M2 derived by second model derivation unit 60 is used as it is as the model to be used in the future will be described.

FIG. 13 is a block diagram illustrating a functional configuration of data analysis device 1A according to the modification of the exemplary embodiment.

As illustrated in FIG. 13, data analysis device 1A includes data acquisition unit 10, data editing unit 20, first model derivation unit 30, change point detection unit 50, second model derivation unit 60, and model selection unit 80A. Data acquisition unit 10, data editing unit 20, first model derivation unit 30, change point detection unit 50, and second model derivation unit 60 have the same configurations as the exemplary embodiment.

Model selection unit 80A of the modification selects second model M2 as the model to be used in the future from first model M1 and second model M2.

Even in data analysis device 1A of the modification, change point Tc of the predetermined explanatory variable (for example, E) is detected, and first model M1 is corrected based on predetermined explanatory variable E starting from change point Tc. Thus, the accuracy of the second model, which is the corrected model, can be improved. As a result, it is possible to provide data analysis device 1A capable of accurately analyzing the plurality of pieces of data.

### CONCLUSIONS

Data analysis device 1 according to the present exemplary embodiment includes data acquisition unit 10 that acquires the plurality of explanatory variables X and E and objective variable Y that can take different values depending on the time, first model derivation unit 30 that performs multiple regression analysis by using the plurality of explanatory variables X and E and objective variable Y and derives first model M1 indicating the relationship between the plurality of explanatory variables X and E and objective variable Y, change point detection unit 50 that detects change point Tc that is the time when the predetermined explanatory variable (for example, E) among the plurality of explanatory variables X and E changes beyond the predetermined range, and second model derivation unit 60 that corrects first model M1 based on predetermined explanatory variable E starting from change point Tc and derives second model M2 that is the corrected model.

As described above, the accuracy of second model M2, which is the corrected model, can be improved by detecting change point Tc of predetermined explanatory variable E and correcting first model M1 based on predetermined explanatory variable E starting from change point Tc. As a result, it is possible to provide data analysis device 1 capable of accurately analyzing the plurality of pieces of data.

In addition, change point detection unit 50 may determine whether or not predetermined explanatory variable E exceeds the predetermined range by using change point score Sc indicating the degree of change of predetermined explanatory variable E.

By determining whether or not predetermined explanatory variable E exceeds the predetermined range by using change point score Sc in this manner, change point Tc can be accurately detected. Thus, first model M1 can be corrected based on predetermined explanatory variable E starting from change point Tc, and the accuracy of second model M2 can be improved. As a result, it is possible to provide data analysis device 1 capable of accurately analyzing the plurality of pieces of data.

In addition, change point detection unit 50 may determine that predetermined explanatory variable E exceeds the predetermined range in at least one of a case where change point score Sc at the second time, which is the time next to the first time, is twice or more change point score Sc at the first time and a case where the change point score at the second time is larger than the change point score at the first time by 20 or more.

Accordingly, change point Tc can be accurately detected. Thus, first model M1 can be corrected based on predetermined explanatory variable E starting from change point Tc, and the accuracy of second model M2 can be improved. As a result, it is possible to provide data analysis device 1 capable of accurately analyzing the plurality of pieces of data.

In addition, change point score Sc may be calculated by using the change point detection algorithm.

Accordingly, change point Tc can be accurately detected. Thus, first model M1 can be corrected based on predetermined explanatory variable E starting from change point Tc, and the accuracy of second model M2 can be improved. As a result, it is possible to provide data analysis device 1 capable of accurately analyzing the plurality of pieces of data.

In addition, second model derivation unit 60 may correct first model M1 by comparing predetermined explanatory variable E at change point Tc with predetermined explanatory variable E at the time before change point Tc.

Accordingly, first model M1 can be appropriately corrected, and the accuracy of second model M2 can be improved. As a result, it is possible to provide data analysis device 1 capable of accurately analyzing the plurality of pieces of data.

In addition, second model derivation unit 60 may obtain the difference between predetermined explanatory variable E at change point Tc and the moving average of predetermined explanatory variable E at the time before change point Tc, and may correct first model M1 based on the difference.

Accordingly, first model M1 can be appropriately corrected, and the accuracy of second model M2 can be improved. As a result, it is possible to provide data analysis device 1 capable of accurately analyzing the plurality of pieces of data.

In addition, the plurality of explanatory variables may include first explanatory variable X and second explanatory variable E, and the predetermined explanatory variable may be second explanatory variable E and may have a larger fluctuation coefficient than first explanatory variable X.

Accordingly, even in a case where the plurality of pieces of data have second explanatory variable E having a larger fluctuation coefficient, the model can be appropriately generated. As a result, it is possible to provide data analysis device 1 capable of accurately analyzing the plurality of pieces of data.

In addition, data analysis device 1 may further include data editing unit 20 that edits the plurality of explanatory variables X and E and objective variable Y acquired by data acquisition unit 10 in association with the time.

As described above, change point Tc can be accurately detected by editing the plurality of explanatory variables X and E and objective variable Y in association with the time. Thus, first model M1 can be corrected based on predetermined explanatory variable E starting from change point Tc, and the accuracy of second model M2 can be improved. As a result, it is possible to provide data analysis device 1 capable of accurately analyzing the plurality of pieces of data.

In addition, data analysis device 1 may further include first prediction value calculation unit 40 that calculates first prediction value P1 corresponding to objective variable Y based on first model M1, second prediction value calculation unit 70 that calculates second prediction value P2 corresponding to objective variable Y based on second model M2, and model selection unit 80 that selects the model to be used in the future from first model M1 and second model M2 based on first prediction value P1 and second prediction value P2.

Accordingly, the model to be used in the future can be appropriately selected. As a result, it is possible to provide data analysis device 1 capable of accurately analyzing the plurality of pieces of data.

In addition, data analysis device 1A may further include model selection unit 80 that selects second model M2 as the model to be used in the future from first model M1 and second model M2.

Accordingly, it is possible to simply and appropriately select the model to be used in the future. As a result, it is possible to provide data analysis device 1A capable of accurately analyzing the plurality of pieces of data.

In addition, the data analysis method according to the present exemplary embodiment includes a step of acquiring the plurality of explanatory variables X and E and objective variable Y that can take different values depending on the time, a step of performing multiple regression analysis by using the plurality of explanatory variables X and E and objective variable Y and deriving first model M1 indicating the relationship between the plurality of explanatory variables X and E and objective variable Y, a step of detecting change point Tc that is the time when the predetermined explanatory variable (for example, E) among the plurality of explanatory variables X and E changes beyond the predetermined range, and a step of correcting first model M1 based on predetermined explanatory variable E starting from change point Tc and deriving second model M2 that is the corrected model.

As described above, the accuracy of second model M2, which is the corrected model, can be improved by detecting change point Tc of predetermined explanatory variable E and correcting first model M1 based on predetermined explanatory variable E starting from change point Tc. As a result, the plurality of pieces of data can be accurately analyzed.

A program according to the present exemplary embodiment is a program for causing a computer to execute the data analysis method described above.

By executing this program, the plurality of pieces of data can be accurately analyzed.

### Other Exemplary Embodiments

While the data analysis device and the like according to the present disclosure have been described above based on the exemplary embodiment, the present disclosure is not limited to the above-described exemplary embodiment. The exemplary embodiment to which various modifications conceivable by those skilled in the art are applied, or another form constructed by combining some constituent elements in the exemplary embodiment is also included in the scope of the present disclosure without departing from the gist of the present disclosure.

For example, in the exemplary embodiment, although the example in which the plurality of pieces of data include two types of first explanatory variables X, one type of second explanatory variable E has been described, one type of objective variable Y, but first explanatory variable X may be one type or three or more types.

In addition, in the exemplary embodiment, although the example in which the plurality of pieces of data include one type of objective variable Y has been described. For example, in a case where the plurality of pieces of data include two or more types of objective variables, the data analysis according to the present exemplary embodiment may be executed on each of the two or more types of objective variables.

In addition, in the exemplary embodiment, although the data in which the data numbers corresponding to the times are arranged in order has been illustrated, the data of the data numbers may be data arranged at equal time intervals or may be data arranged at different time intervals. The data of the data number may be thinned data obtained by skipping the data finely arranged in time series instead of sequentially.

For example, the data analysis device may be specifically a computer system including a microprocessor, a ROM, a RAM, a hard disk drive, a display unit, a keyboard, a mouse, and the like. A data analysis program is stored in the RAM or the hard disk drive. The microprocessor operates according to the data analysis program, and therefore the data analysis device achieves the functions. Here, the data analysis program is obtained by combining a plurality of command codes indicating commands to the computer in order to achieve a predetermined function.

Further, a part or all of the constituent elements constituting the data analysis device may be constituted by one system large scale integration (LSI). The system LSI is a super multifunctional LSI manufactured by integrating a plurality of components on one chip, and is specifically a computer system including a microprocessor, a ROM, a RAM, and the like. The RAM stores the computer program. By the microprocessor operating in accordance with the computer program, the system LSI achieves its functions.

Furthermore, some or all of the constituent elements constituting the data analysis device may include an IC card detachable from a computer or a single module. The IC card or the module is a computer system including a microprocessor, a ROM, a RAM, and the like. The IC card or the module may include the above-described super multifunctional LSI. The microprocessor operates in accordance with the computer program, whereby the IC card or the module achieves its function. The IC card or the module may have tamper resistance.

In addition, the present disclosure may be a data analysis method executed by the above-described data analysis device. In addition, this data analysis method may be implemented by the computer executing the data analysis program, or may be implemented by a digital signal including the data analysis program.

Further, the present disclosure may include a non-transitory recording medium capable of reading the data analysis program or the digital signal. Examples of the recording medium include a flexible disk, a hard disk, a CD-ROM, an MO, a DVD, a DVD-ROM, a DVD-RAM, a Blu-ray (registered trademark) disc (BD), and a semiconductor memory. In addition, the data analysis program may include the digital signal recorded in the non-transitory recording medium.

In addition, the present disclosure may include a data analysis program or a digital signal transmitted via an electric communication line, a wireless or wired communication line, a network represented by the Internet, data broadcasting, or the like.

In addition, the present disclosure may be a computer system including a microprocessor and a memory, and the memory may store the above-described data analysis program, and the microprocessor may operate in accordance with the data analysis program.

In addition, the data analysis program or the digital signal may be transferred while being recorded on the non-transitory recording medium, or the data analysis program or the digital signal may be transferred via the network or the like. As a result, the data analysis program or the digital signal may be implemented by another independent computer system.

In addition, the data analysis system may include a server and a terminal connected to the server via a network and possessed by a user.

According to the data analysis device and the like of the present disclosure, the plurality of pieces of data can be accurately analyzed.

### INDUSTRIAL APPLICABILITY

The data analysis device of the present disclosure can be applied to data analysis such as prediction of an objective variable with high accuracy. In addition, since the condition that satisfies a target value of the objective variable can be predicted and calculated with high accuracy, for example, the present disclosure can be applied to data analysis such as calculation and instruction of an optimal manufacturing condition by using data. In addition, for example, it can be used for supporting manufacturing work.

### REFERENCE MARKS IN THE DRAWINGS

1, 1A data analysis device
10 data acquisition unit
20 data editing unit
30 first model derivation unit
40 first prediction value calculation unit
50 change point detection unit
60 second model derivation unit
70 second prediction value calculation unit
80, 80A model selection unit
101 input unit
102 arithmetic circuit
103 memory
104 output unit
105 storage
105a program
105b temporary data
106 database
107 communication unit
500 manufacturing management device
900 data analysis system
Ds data set
E second explanatory variable (predetermined explanatory variable)
M1 first model
M2 second model
P1 first prediction value
P2 second prediction value
Sc change point score
Tc change point
X first explanatory variable
Y objective variable

1. A data analysis device comprising:
a data acquisition unit that acquires a plurality of explanatory variables and an objective variable that takes different values depending on a time;
a first model derivation unit that performs multiple regression analysis by using the plurality of explanatory variables and the objective variable and derives a first model indicating a relationship between the plurality of explanatory variables and the objective variable;
a change point detection unit that detects a change point that is a time when a predetermined explanatory variable among the plurality of explanatory variables changes beyond a predetermined range; and
a second model derivation unit that corrects the first model based on the predetermined explanatory variable starting from the change point and derives a second model that is a corrected model.

2. The data analysis device according to claim 1, wherein the change point detection unit determines whether or not the predetermined explanatory variable exceeds the predetermined range by using a change point score indicating a degree of change of the predetermined explanatory variable.

3. The data analysis device according to claim 2, wherein the change point detection unit determines that the predetermined explanatory variable exceeds the predetermined range in at least one of a case where the change point score at a second time that is a time next to a first time is twice or more the change point score at the first time and a case where the change point score at the second time is larger than the change point score at the first time by 20 or more.

4. The data analysis device according to claim 3, wherein the change point score is calculated by using a change point detection algorithm.

5. The data analysis device according to claim 1, wherein the second model derivation unit corrects the first model by comparing the predetermined explanatory variable at the change point with the predetermined explanatory variable at a time before the change point.

6. The data analysis device according to claim 5, wherein the second model derivation unit obtains a difference between the predetermined explanatory variable at the change point and a moving average of the predetermined explanatory variable at the time before the change point, and corrects the first model based on the difference.

7. The data analysis device according to claim 1, wherein
the plurality of explanatory variables include a first explanatory variable and a second explanatory variable, and
the predetermined explanatory variable is the second explanatory variable, and has a larger fluctuation coefficient than the first explanatory variable.

8. The data analysis device according to claim 1, further comprising a data editing unit that edits the plurality of explanatory variables and the objective variable acquired by the data acquisition unit in association with a time.

9. The data analysis device according to claim 1, further comprising:
a first prediction value calculation unit that calculates a first prediction value corresponding to the objective variable based on the first model;
a second prediction value calculation unit that calculates a second prediction value corresponding to the objective variable based on the second model; and
a model selection unit that selects a model to be used in future from the first model and the second model based on the first prediction value and the second prediction value.

10. The data analysis device according to claim 1, further comprising a model selection unit that selects the second model as a model to be used in future from the first model and the second model.

11. A data analysis method comprising:
acquiring a plurality of explanatory variables and an objective variable that take different values depending on a time;
performing multiple regression analysis by using the plurality of explanatory variables and the objective variable and deriving a first model indicating a relationship between the plurality of explanatory variables and the objective variable;
detecting a change point that is a time when a predetermined explanatory variable among the plurality of explanatory variables changes beyond a predetermined range; and
correcting the first model based on the predetermined explanatory variable starting from the change point, and deriving a second model that is a corrected model.

12. A program for causing a computer to execute the data analysis method according to claim 11.
